(19) United States
(12) Patent Application Publication
(10) Pub. No.: US 2012/0118849 A1
(43) Pub. Date: May 17, 2012

(54) Locking Bottle Preform

(76) Inventor: Michael D. Harper, Fort Worth, TX (US)

(21) Appl. No.: 13/293,808

(22) Filed: Nov. 10, 2011

Related U.S. Application Data
(60) Provisional application No. 61/412,233, filed on Nov. 10, 2010.

(51) Int. Cl. B65D 1/02; B29C 49/00

(52) U.S. Cl. 215/40; 264/523

(57) ABSTRACT

A preform to be used to create a plastic bottle has a substantially cylindrical body and a rounded cap at a top portion of the body. The preform also has a neck extending from the body, the neck has threading around at least a portion of an outer surface of the neck. A lip separates the neck from the body, and the lip has a larger diameter than the neck.

### CROSS-REFERENCE TO RELATED APPLICATION

This application claims priority from U.S. Provisional Patent Application Ser. No. 61/412,233 entitled “Locking Bottle Preform” filed Nov. 10, 2010, the disclosures of which are incorporated herein by reference.

### FIELD OF THE INVENTION

The present invention relates to a method of manufacturing plastic containers. More specifically, the present invention relates to a preform and manufacturing process for creating a plastic container.

### BACKGROUND OF THE INVENTION

Plastic containers are used in a number of different areas, for instance, as drinking bottles, food storage, animal feeding/watering storage tanks, and the like. One method of creating plastic containers is to blow or otherwise expand a preform or other workpiece into a final product of a larger size within a mold. However, the exact dimensions of the final product after the expansion stage often cannot be precisely controlled. The lack of control can be a problem since plastic containers are often designed to be used with a particular cap or to be attached to a particular apparatus. If the dimensions are different than anticipated, the plastic containers may not fit the caps and/or other apparatuses. Additionally, as the dimensions of the preform change significantly during the expansion stage, threads and other connecting elements have typically not been added to the preform because the dimensions of the final product cannot always be predicted with certainty.

### BRIEF SUMMARY OF THE INVENTION

Certain embodiments take the form of a preform to be used to create a plastic bottle having a substantially cylindrical body and a rounded cap at a top portion of the body. The preform also has a neck extending from the body opposite the cap, and the neck has a thread around at least a portion of an outer surface of the neck. A lip separates the neck from the body, and the lip has a diameter that is larger than that of the neck.

Other embodiments disclosed include a method for creating a plastic container. The method includes molding a preform. The preform has a substantially cylindrical body, a cap at a top surface of the body, a neck extending from a bottom portion of the body, and a flange disposed between the body and the neck. Heating the preform. Then securing the preform into a blow-mold machine, where the preform is substantially prevented from moving. Then expanding the preform.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is an isometric view of a preform.

FIG. 2 is an elevation view of the preform illustrated in FIG. 1.

FIG. 3 is a top plan view of the preform illustrated in FIG. 1.

FIG. 4 is a flow chart demonstrating operations for forming a bottle.

FIG. 5 is an isometric view of the preform secured to a cylindrical platform prior to the heating operation.

FIG. 6 is a top view of the preform secured to a blow-mold machine prior to the blowing operation.

FIG. 7 is a top view of the preform secured to the blow-mold machine after the blowing operation.

FIG. 8 is an isometric view of the preform formed into a bottle after the blowing operation.

### DETAILED DESCRIPTION

Disclosed herein is a preform and process for creating a plastic container. The preform includes a cylindrical body having a lip or flange extending about a circumference of the body. A neck extends away from the lip, and the neck may include threading or other keying structures allowing the formed bottle (after it has been through the entire expansion process) to securedly attach to a cap, base or the like. The neck in some embodiments advantageously remains substantially the same size after the preform has been blow or otherwise expanded into its full shape. The preform may be made out of a thick plastic that may then be expanded such that the thickness of the walls is substantially reduced and the overall width of the bottle is substantially increased. The top of the preform may be a rounded cap and the bottom may be open, such that the preform may be used as a bottle or other container.

Once the preform has been created, via an injection molding process or other appropriate process, the preform may then be heated. After being heated the preform may be secured to a machine within a blow-mold, and the preform may be expanded and/or blown. During this operation the height and/or width of portions of the preform are expanded and are substantially increased in dimension. However, the neck and the open end of the preform may advantageously remain substantially the same height and/or width. These embodiments allow the threading and/or other keying structures to remain the same as before the blowing/expansion process and allow the preform to be created with threading on its outer surface whose dimensions are reliable. Once blown or expanded the preform may be used as a container/bottle to store a variety of different substances. The bottle may be used in a variety of applications, such as a water bottle, a storage tank for feeding/water apparatuses, and the like.

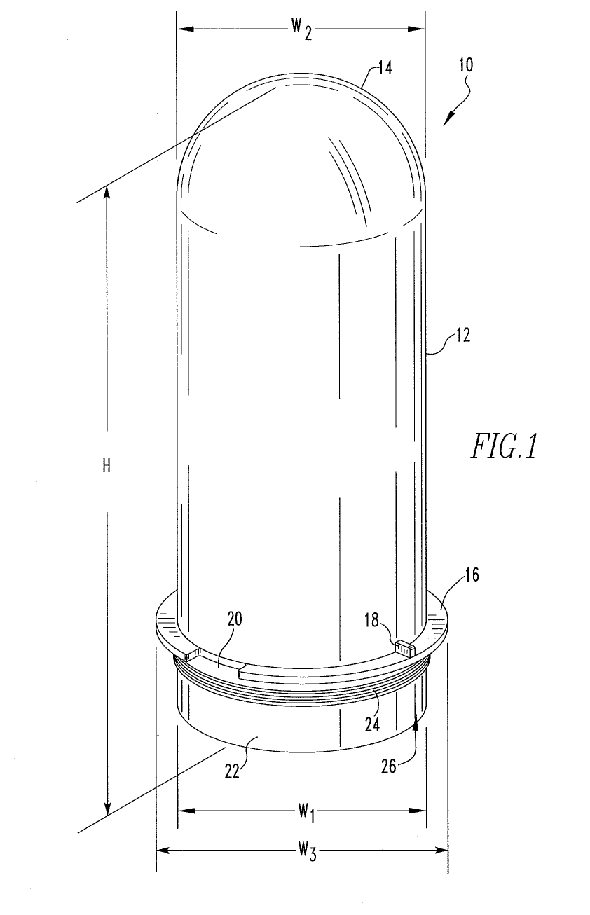

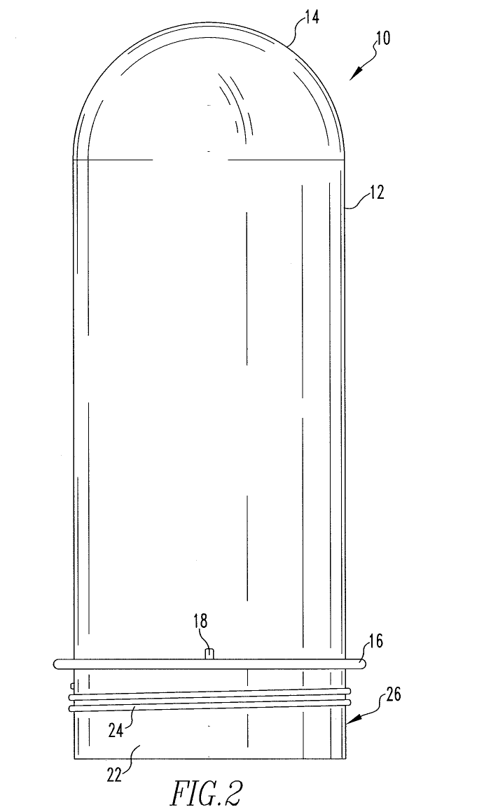

FIG. 1 is an isometric view of an implementation of a preform, FIG. 2 is an elevation view of the preform. Referring to FIGS. 1 and 2, the preform 10 includes a body 12, a top 14, a lip 16 or flange, and a neck 26. The preform 10 may be a unitary piece, such that the body 12, top 14, lip 16, and neck 26 may be co-formed together as a single-piece unit. The preform 10 may be created via an injection molding process or the like. In these embodiments, the preform 10 is formed of a single material and forms a continuous/unitary piece.

The preform 10 may be created out of any of a variety of plastic or thermoplastic material, such as polyethylene terephthalate. In some embodiments the preform 10 may be constructed out of a non-toxic material, such as polyvinyl chloride, polytetrafluoroethylene, or other appropriate polymer. However, in embodiments where the resultant product is not intended for use in storing substances that may be consumed or handled by humans and/or animals, then other materials may be used. Furthermore, in some embodiments dyes or other coloring may be added to the material used for the preform 10.

The preform 10 has a height H measured from the end of the neck 26 to the end of the top 14. The height H depends on the desired final height of the product after it has been through the expansion process. For instance, if the preform 10 is used to create a small water bottle, the height H will be much less than if the preform 10 is used to create a large storage tank or the like. The preform 10 also has a first width W1 measured across the diameter of the neck 26 and a second width W2 measured across the diameter of the top 14. As with the height H, the two widths W1 and W2 may be altered according to the widths of the final product created from the preform 10. The first width W1 does not significantly change after the expansion process. The lip 16 has a width W3 across its diameter that is greater than W1 and W2. In these embodiments, the first width W1 may be designed to accommodate the desired connecting apparatuses/elements to be used with the final product. For example, if the final product is to be attached to a cap, the first width W1 may advantageously be originally created to be the desired width of the cap.

Additionally, the walls of the preform 10 may have a constant or varying thickness through the length of the body 12, top 14, and neck 26. In some embodiments, the body 12 may have a thickness greater than that of the neck 26, and in other embodiments the body 12 and the neck 26 may have the same thickness.

In some embodiments the body 12 may be of a substantially cylindrical shape and be integrated with the top 14. In these embodiments, the final product (i.e. after being through the expansion process) may be generally rounded. However, in embodiments where other final shapes are desired, the shape of the body 12 may be varied in order to accommodate other final shapes. For example, the body 12 may be square or rectangular allowing the final shape after expansion to be somewhat square and/or rectangular. Similarly, the body 12 may include ridges and/or other changes in the shape to create variations in the shape of the final product.

The top 14 of the body may be a variety of different shapes and/or sizes. However, in the embodiment illustrated in FIG. 1, the top 14 may be rounded to allow the final product to have a rounded top. However, as with the body 12, the shape and size of the top 14 may be varied in accordance with the desired shape of the final product. The body 12 may seamlessly integrate with the top 14, or there may be ridges and/or seams between the body 12 and the top 14. Additionally, although the top 14 has been illustrated as solid, the top 14 may include openings or apertures. For example, if the final product is not going to be used a container, but as a conduit or the like, the top 14 may be include an aperture or the like.

FIG. 3 is a top plan view of the preform 10. Referring to FIGS. 1-3, the flange or lip 16 separates the body 12 from the neck 26 and is disposed therebetween. However, the neck 26, body 12, and lip 16 may be a unitary element. The lip 16 in some instances may be omitted, depending on the desired overall shape of the final product, however in these embodiments the lip 16 may be used as a flange to allow the expanded preform 10 to connect or secure to a variety of different devices. For example, in this embodiment, the lip 16 includes cutouts 20 or recessed portions along with raised tabs 18 or extensions intermittently placed along the lip 16. The diameter of the lip 16 may be reduced at the locations of the cutouts 20.

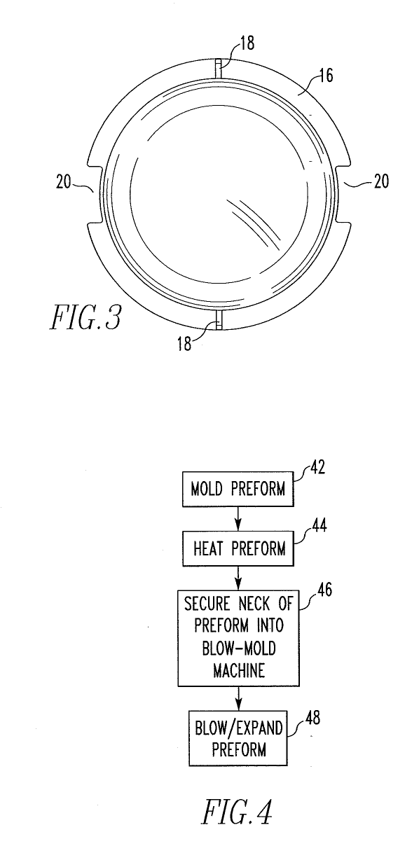

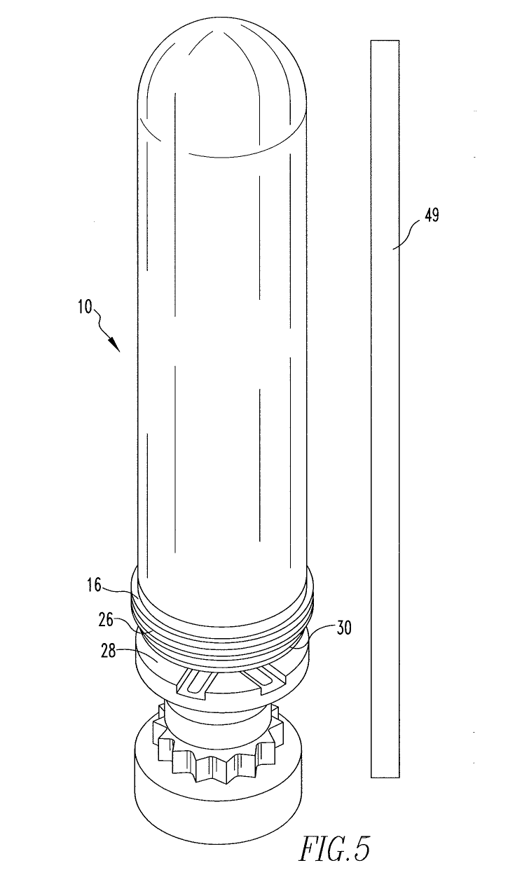

The cutouts 20 and raised tabs 18 may be designed to be complementary to a cap or stand for the final product. For instance, in some embodiments the expanded preform 50 (as shown in FIG. 8) may be used as a storage tank for an animal feeding/watering device, and the cutouts 20 and tabs 18 may allow the expanded preform 10 to twist-lock to a stand for supporting the storage tank (i.e. the expanded preform 50). For example, as the neck 26 is inserted into a stand or the like, the cutouts 20 may lock with corresponding tabs or extending pieces, and the raised tabs 18 may prevent the preform 10 from being rotated past a certain location in the stand. The lip 16 may also be used to secure the preform 10 to a heating and/or blowing machine. This is discussed in further detail with regard to FIGS. 4 and 5. However, in other embodiments the lip 16 may be solid and have uniform dimensions and the cutouts 20 and/or tabs 18 may be omitted.

The neck 26 extends from the body 12 past the lip 16 and may be used to attach the preform 10 to the heating and/or blow-mold machines. Additionally, the neck 26 may be open at its distal end allowing the preform 10 to be blown (i.e. have air or the like inserted through the neck 26 expanding the body 12), as well as to allow the expanded preform 10 to have an opening and neck area. The neck 26 in some embodiments may include threading in the form of at least a first thread 24 on a cylindrical outer surface 22 thereof. The threading 24 may be used to allow the expanded preform 10 to connect to other elements. For example, the expanded preform 10 may attach to a cap that has corresponding threading and that screws or twists onto the distal end of the neck 26 via the threading.

The neck 26, including the threading 24, may be created to fit the desired dimensions of the final product. In these embodiments the neck 26 and threading 24 do not meaningfully change in shape or size during the expansion process. The lack of change advantageously allows the preform 10 to be configured with the threading 24 and/or other keying elements as the threading 24 will not change and may be designed to fit into a variety of different apparatuses (i.e. caps, supports or bases and the like). These embodiments also allow the threading 24 to be molded to the preform 10 when the preform 10 is created. These embodiments may eliminate additional manufacturing steps wherein the preform 10 is first expanded, after which threads or other keying structures may be added.

FIG. 4 is a flow chart illustrating operations for using the preform 10 to create an expanded final product. Operations begin with operation 42 in which the preform 10 is molded or otherwise created. As discussed above, the preform 10 may be created via injection molding or other appropriate molding processes. In this operation 42, the preform 10 may be created in a variety of shapes and/or sizes, depending on the desired final product (e.g. expanded preform 50 illustrated in FIG. 8). Furthermore, the thickness of the walls of the preform 10 may be configured in this operation 42 depending on the desired thickness of the desired final product.

After the preform 10 is created, in operation 44 the preform 10 may be heated. This operation 44 may be performed via an infrared heater 49 (as depicted in FIG. 5), an oven, or other appropriate heating apparatus. It should be noted that in some embodiments, this operation 44 may be omitted. For example, if injection blow molding is used to expand the preform 10, the preform 10 may be created by pouring plastic or the like into a heated mold and by then immediately blowing the warm plastic into the desired shape.

FIG. 5 illustrates the preform 10 attached to heating machine, according to some embodiments. As shown in FIG. 5, the preform 10 may be attached or secured to a platform 28 via the neck 26. An upper area 30 of the platform 28 may extend inside the neck 26 in order to secure the preform 10 to the platform 28. In this embodiment, the platform 28 rotates through the heating apparatus, which is depicted as the infrared heater 49, thus rotating the preform 10 through the heating apparatus. It should be noted that although FIG. 5 illustrates a particular implementation of operation 44, this operation 44 may be performed by any suitable method and/or heating apparatus.

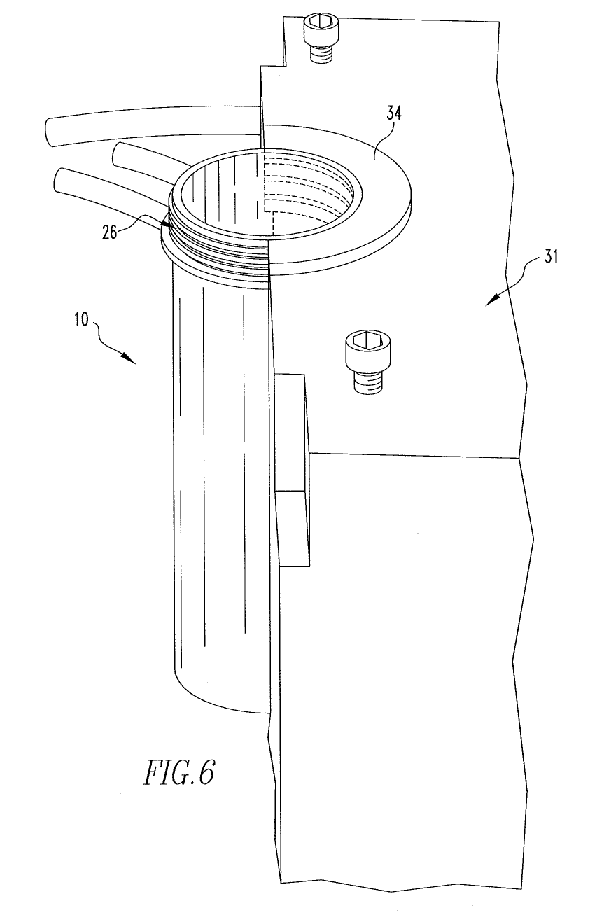

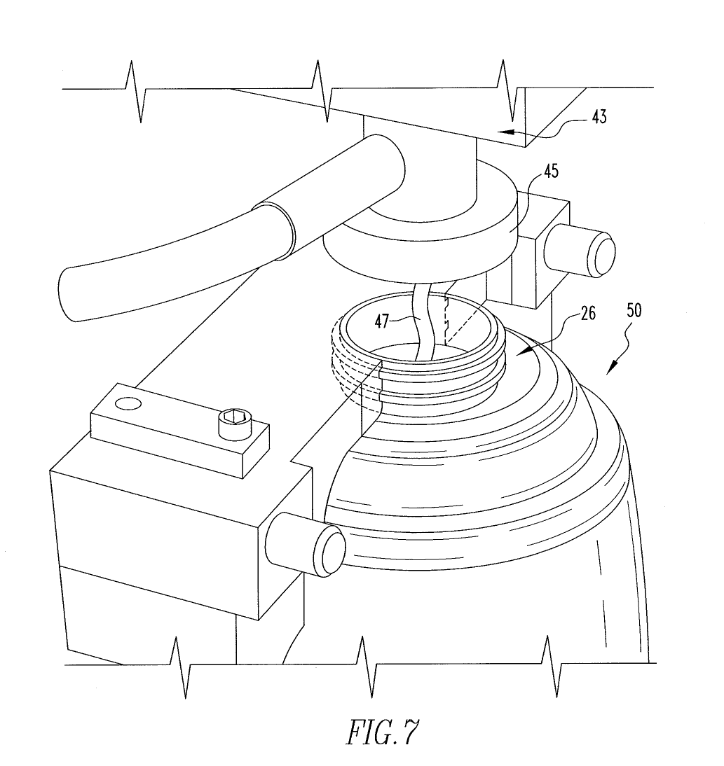

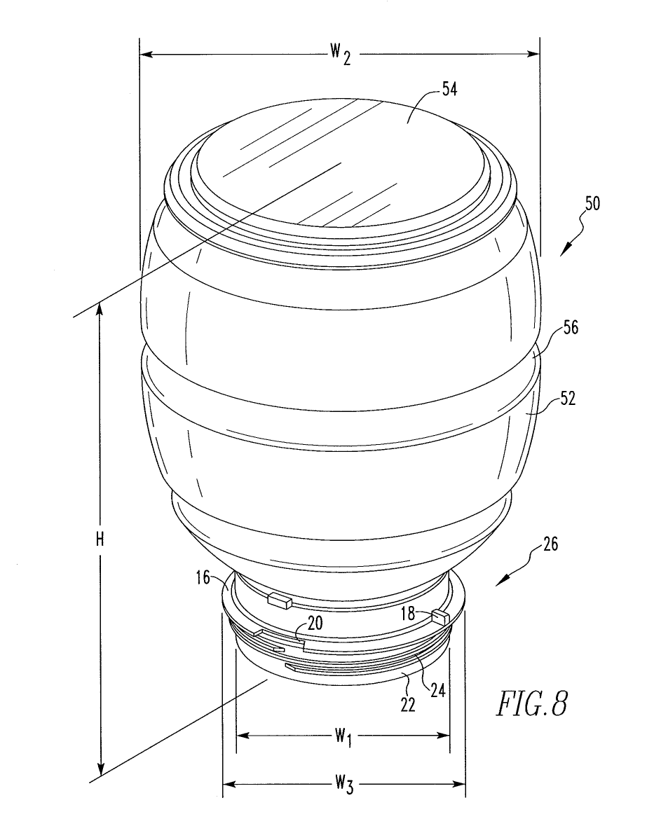

Referring again to FIG. 4, after the preform 10 has been heated, in operation 46 the neck 26 of the preform 10 may be secured into a blow-mold or expansion machine. FIG. 6 illustrates an embodiment of the preform 10 secured within a first half of a blow-mold, stretch-blow or expansion machine. As shown in FIG. 6, the neck 26 may be inserted partially (or completely depending on the type of machine used) into a securing ring 34. The securing ring 34 is attached to the machine body 31. The preform 10 may be secured in a variety of other ways, and FIG. 6 is simply one implementation. The neck 26 may be secured such that the neck 26 and the preform 10 are immovable while secured, and the securing ring 34 fits over the neck 26. Additionally, the securing ring 34 can be said to be an upper portion of a blow-mold, and the preform 10 is enclosed by two-sides of the mold (one side of which is depicted in FIG. 6, and the other side of which is depicted in FIG. 7). Thus, when secured within the blow-mold machine, the preform 10 is essentially encased within the blow-mold cavity. It should be noted that the preform 10 may be secured within the blow-mold machine in a variety of ways and the description above is simply one implementation.

After the preform 10 has been secured to the blow-mold machine, in the next operation 48 the preform 10 is expanded. As shown in FIG. 7, a fitting 45 connected to a tube 47 may be designed to fit on top of the neck 26 of the preform 10. After the fitting 45 has been secured and the mold is fitted around the preform 10, air or other pressurized substances are distributed through the tube 47 into the preform 10 via the neck 26. The tube 47 extends into the preform 10 past the neck 26 area, allowing the pressurized air or the like to bypass the neck 26 region, thus resisting the neck 26 from being expanded.

As the pressurized air is distributed into the preform 10, the body 12 and top 14 of the preform 10 may then expand significantly and increase in size. As discussed above, the blow or stretch machine may include a mold that is fitted around the preform 10 before and during expansion. The shape of the mold may be altered in order to vary the finalized shape of the preform 10. In these embodiments, the preform 10 may expand and be shaped by the mold, for instance as the preform 10 is expanding the walls of the body 12 will hit the sides of the mold and be prevented from expanding further in that particular direction/area. Thus, the expanded preform 50 may include ridges, or the like, along the body 52 due to either the original shape of the preform 10 or the blow-mold operation 44.

FIG. 8 is an isometric view of an embodiment of the expanded preform 50. In this embodiment the expanded preform 50 includes a body 52 and a top 54, both of which are substantially increased in size from the body 12 and top 14 of the preform 10. The expanded preform 50 also includes the neck 26, lip 16, and threading 24. After operation 48, the height H and second width W2 are increased in size. However, as shown in FIG. 8, the first width W1 and the width of the lip 16 W3 do not substantially increase in size. In these embodiments, the neck 26 including the lip 16 of the expanded preform 50 may remain substantially the same size as the un-expanded preform 10. This may be accomplished via the securing ring 34 that attaches to the neck 26 during operation 44, or through other fashions of restricting expansion of the neck. Additionally, the expanded preform 50 may include ridges 56 after the expansion process. This may be created by altering the original preform 10 shape or via the actual expansion (i.e. via the shape of the blow mold).

The thickness of the walls of the expanded preform 50 may be substantially reduced, however that in some embodiments the thickness of the neck 26 walls may remain substantially the same as in the original preform 10. As the neck 26 remains essentially the same shape and size, the final dimensions of the expanded preform 50 may be more accurately predicted and thus help to reduce and/or eliminate errors due to the expansion process.

The foregoing describes some example embodiments to achieve a continuous water filtration watering system for animals. Although the present invention has been described with reference to illustrated embodiments, persons skilled in the art will recognize that changes may be made in form and detail without departing from the spirit and scope of the invention. Indeed, in other embodiments, the dispenser design may be used in other applications besides pet feeding and watering devices, for example in human food/water storage. Furthermore, it should be appreciated that other components may be added to the dispenser. For example, a pump may be used to circulate fluid within the access basin 12 or to pump water from the storage tank 16 into the access basin 12. Accordingly, the specific embodiments described herein should be understood as examples and not limiting the scope of the disclosure.

What is claimed is:

1. A preform structured to used for creating a plastic bottle, the preform comprising:
a substantially cylindrical body;
a cap at an end of the body;
a neck extending from another end of the body and having a diameter, the neck comprising at least a first thread situated on at least a portion of an outer surface of the neck; and
a lip disposed between the body and the neck, the lip having a diameter larger than the diameter of the neck.

2. The preform of claim 1, wherein the body and the neck have substantially the same diameter.

3. The preform of claim 2, wherein the preform is structured such that after a blowing process the diameter of the body is substantially larger than a diameter of the neck.

4. The preform of claim 2, wherein the preform is structured such that after the blowing process the neck and the lip retain substantially the same diameter.

5. The preform of claim 1, wherein the lip has a cutout formed therein, wherein the diameter of the lip at the cutout is smaller than at other regions of the lip.

6. The preform of claim 1, wherein the lip comprises a tab attached to an upper surface of the lip.

7. The preform of claim 6, wherein the tab is radially oriented and extends in a direction parallel with the longitudinal extent of the body.

8. A method for creating a plastic container comprising:
molding a preform having a substantially cylindrical body, a cap at an end of the body, a neck extending from another end of the body, and a flange disposed between the body and the neck;
heating the preform;
securing the preform into a blow-mold machine, wherein the preform is substantially prevented from moving; and
expanding the preform.

9. The method of claim 8, wherein the molding of the preform includes molding the neck to have at least a first thread on an outer surface of the neck.

10. The method of claim 8, wherein the expanding of the preform comprises:
inserting a tube into the neck of the preform, wherein the tube extends into the preform at least partially past the neck; and
flowing fluid at an increased pressure into the body of the preform.

11. The method of claim 8, wherein the securing of the preform comprises enclosing the preform within a blow-mold.

12. The method of claim 11, wherein the securing of the preform comprises enclosing the preform within a blow-mold that is configured to allow the preform to substantially expand in size.

13. The method of claim 8, wherein the molding of the preform comprising molding the preform to have the neck and the body being of substantially the same diameter.

14. The method of claim 8, wherein the expanding of the preform comprises expanding the preform such that the neck has substantially the same dimensions as before the preform was expanded.

15. The method of claim 14, wherein the expanding of the preform further comprises expanding the preform such that the body has a larger diameter than before the preform was expanded.

16. The method of claim 15, wherein the expanding of the preform further comprises expanding the preform such that the body and the neck have different diameters.

17. The method of claim 8, wherein the expanding of the preform further comprises expanding the preform such that the flange is substantially the same dimensions as before the preform was expanded.
